(19) United States
(12) Patent Application Publication
(10) Pub. No.: US 2023/0416148 A1
(43) Pub. Date: Dec. 28, 2023

(54) INORGANIC BINDING MATERIALS WITH ALKYL-MODIFIED SILSESQUIOXANE NANO PARTICLES

(71) Applicant: Dow Silicones Corporation, Midland, MI (US)

(72) Inventors: Steven Swier, Midland, MI (US); Jean-Paul Lecomte, Brussels (BE); Frederick Campeol, Seneffe (BE)

(21) Appl. No.: 18/251,900

(22) PCT Filed: Feb. 11, 2022
(86) PCT No.: PCT/US2022/016120

§ 371 Date: May 5, 2023

Related U.S. Application Data
(60) Provisional application No. 63/155,794, filed on Mar. 3, 2021.
(60) Provisional application No. 63/155,794, filed on Mar. 3, 2021.

(51) Int. Cl. C04B 24/42; C04B 11/26; C04B 28/14

(52) U.S. Cl. CPC C04B 24/42; C04B 11/26; C04B 28/14; C04B 2111/0062

(57) ABSTRACT

A composition contains a mixture of an inorganic binder and alkyl-modified silsesquioxane resin particles, where the alkyl-modified silsesquioxane resin particles are distributed throughout the inorganic binder and have an average particle size in a range of 20 to 200 nanometers as determined by dynamic light scattering.

### FIELD OF THE INVENTION

The present invention relates to alkyl-modified silsesquioxane nano particle additives for inorganic binding materials such as gypsum and cement-based binders.

### INTRODUCTION

Inorganic binders commonly used in the construction industry include cement and gypsum. These binders are typically cast from an aqueous mixture and allowed to set up and eventually dry. Since the binder sets up before drying, the water that dries from the set binder leaves behind voids causing the set-up binder to be porous. The resulting binders also tend to be inherently hydrophilic due to their chemical composition and the presence of hydrophilic components in the binder. As a result, the set-up binders often readily absorb water into their porous interstices. That can be undesirable. Absorbed water that freezes can fracture the binding materials. Gypsum wall board can soften, lose mechanical strength and become easily damaged when wet and can enable mold formation in and on the binder. Therefore, there is a desire to identify ways to increase the hydrophobicity of inorganic binding materials.

Application of a hydrophobic coating to the surface of an inorganic binder after it is set up is one way to protect the binder from water absorption. However, surface coatings can wear away exposing the hydrophilic binder, can change the appearance of the binder, and/or cannot be processed industrially if the binder is covered with a paper facing sheet (such as is the case with gypsum board). The binder can also fracture exposing hydrophilic surfaces of the binder. Hence, it is desirable to identify ways to increase the hydrophobicity of inorganic binder throughout the binder composition rather than just on exposed surfaces.

There are several common ways currently used to increase the hydrophobicity of inorganic binders, particularly gypsum, by blending in silicon-based hydrophobizing agents such as methyl hydrogen siloxane, siliconates and film forming silicone resins.

Methyl hydrogen siloxane additives include DOWSIL™ MH 1107 Fluid (DOWSIL is a trademark of The Dow Chemical Company), which has been used for decades as a hydrophobizing agent for gypsum. When used at a loading of 0.5 weight-percent (wt %) based on dry weight of non-hydrated gypsum, DOWSIL™ MH 1107 Fluid can reduce water uptake in the resulting gypsum from 40 to 10 weight-percent (wt %) relative to binder composition weight. Si—H groups in the hydrophobizing agent react with water, creating a labile pendant silanol that can cross link to create a rubbery structure inside the pores of a gypsum matrix. There are drawbacks to using methyl hydrogen siloxanes including the fact they inhibit foaming of the gypsum slurry when making gypsum boards and can result in fumes of cyclics and hydrogen when drying gypsum boards, presumably due to depolymerization of the hydrophobizing agent. Release of cyclics is particularly undesirable because they can turn to silica in the burners of driers.

Siliconates can be added to a mix of inorganic binder and as the binder dries the siliconates react with ambient carbon dioxide to create Na₂CO₃ or K₂CO₃ and silanols. The silanols crosslink with one another to form a silsesquioxane resin in the pores of the inorganic binder which increases the hydrophobicity of the binder. However, siliconates can change the setting time for inorganic binders, which is undesirable especially in continuous manufacturing processes such as those used in making gypsum boards. Reactive additives also tend to have short shelf-life stability that precludes preparing bulk dispersions for use over several days.

Film forming alkoxy silicone resins are thought to form a film or gel inside pores of inorganic binders thereby inhibiting water penetration and increasing hydrophobicity of the inorganic binder. Alkoxy silicone resins are not easily water dispersible and need to be emulsified to be mixed easily within aqueous slurries of inorganic binder materials. Alkoxy resins also tend to release methanol as a by-product of their reaction.

It is desirable and would advance the art of inorganic binder materials to identify an additive that increases the hydrophobic character of the inorganic binder without fume generation like methyl hydrogen siloxane. It is also desirable for a hydrophobizing additive to be readily dispersible in an aqueous solution of inorganic binder material. It would further be desirable if the additive was essentially non-reactive so that it is shelf stable prior to mixing with a binder composition and yet more desirable if the additive did not have to be film forming.

### BRIEF SUMMARY OF THE INVENTION

The present invention provides a solution to the problem of identifying an additive that increases the hydrophobic character of the inorganic binder without fume generation like methyl hydrogen siloxane additive. The hydrophobizing agent of the present invention is readily dispersible in aqueous solution. Moreover, the present invention provides a hydrophobizing additive that is essentially non-reactive prior to adding to a binder composition and that is not film-forming.

The present invention is particularly useful with gypsum, which is particularly difficult to hydrophobize with an additive because gypsum does not have hydroxyl groups that can bond with silane and siloxane hydrophobizing agents. The present invention is a result of discovering an additive that does not require reacting with such reactive groups on the inorganic binder in order to increase hydrophobicity of the inorganic binder.

The present invention is a result of discovering that by adding a dispersion of nano-sized alkyl-modified silsesquioxane resin particles to an inorganic binder solution causes the resulting inorganic binder to be more hydrophobic. Since the alkyl-modified silsesquioxane resin particles are already in a nearly fully condensed form—they contain less than 30 mol-percent (mol %) reactive groups selected from Si—OH, Si—OR and Si—H groups per silicon atom on average per molecule so as to be “essentially non-reactive”--they are less reactive than alternative hydrophobizing additives that are added as reactive silanes for instance and are expected to be more shelf stable prior to adding to the binder composition. As essentially non-reactive particles, they remain as particles that are not chemically bound to the binder before or after setting of the binder composition. Additionally, the alkyl-modified silsesquioxane resin particles are expected to be more efficient at increasing the hydrophobic character of an inorganic binder over reactive additives, meaning less additive is needed to achieve hydrophobizing effect.

Surprisingly, the nano-sized alkyl-modified silsesquioxane resin particles can introduce hydrophobic character to inorganic binder even though they are essentially non-reactive. Moreover, the nano-sized alkyl-modified silsesquioxane resin particles are not film forming, meaning they do not form a film when heated or allowed to dry.

In a first aspect, the present invention is a composition comprising a mixture of an inorganic binder and alkyl-modified silsesquioxane resin particles, where the alkyl-modified silsesquioxane resin particles are distributed throughout the inorganic binder and have an average particle size in a range of 20 to 200 nanometers as determined by dynamic light scattering.

In a second aspect, the present invention is a method for preparing the composition of claim 1, the method comprising: (a) providing an aqueous dispersion of inorganic binder and an aqueous dispersion of alkyl-modified silsesquioxane resin particles have an average particle size in a range of 20 to 200 nanometers as determined by dynamic light scattering; and (b) mixing together the aqueous dispersion of inorganic binder and the aqueous dispersion of alkyl-modified silsesquioxane resin particles to form an aqueous dispersion of inorganic binder and alkyl-modified silsesquioxane resin particles.

### DETAILED DESCRIPTION OF THE INVENTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods; END refers to European Norm; DIN refers to Deutsches Institut für Normung; ISO refers to International Organization for Standards; and UL refers to Underwriters Laboratory.

Products identified by their tradename refer to the compositions available under those tradenames on the priority date of this document.

“Multiple” means two or more. “And/or” means “and, or as an alternative”. All ranges include endpoints unless otherwise indicated.

“Alkyl” refers to a hydrocarbon radical derivable from an alkane by removal of a hydrogen atom. An alkyl can be linear or branched.

“Dispersion” refers to a mixture of materials comprising particles of one material that are dispersed in a continuous phase of another material. If the particles are large enough to undergo sedimentation the dispersion is a “suspension”, otherwise the dispersion is a “colloid” or “solution”.

The present invention is a composition comprising a mixture of an inorganic binder and alkyl-modified silsesquioxane resin particles distributed through the inorganic binder. “Inorganic binder” refers to gypsum, cement and cement-based materials (for example, mortar). Preferably, the present invention applies to a mixture of gypsum with alkyl-modified silsesquioxane resin particles. Gypsum is particularly difficult to render hydrophobic yet the alkyl-modified silsesquioxane resin particles success in increasing the hydrophobicity of inorganic binder, even gypsum.

Alkyl-modified silsesquioxane resin particles are particles of polysiloxane resin comprising siloxane units where at least 90 mol-percent (mol %), and can be 95 mol % or more, even 98 mol % or more of the siloxane resin units are RSiO_{3/2} siloxane units where R is an alkyl group, preferably an alkyl group having from 1-10 carbon atoms, more preferably R is selected from methyl, ethyl, propyl, butyl, pentyl and hexyl groups.

The alkyl-modified silsesquioxane resin particles can be made in an aqueous mixture of alkyl trimethoxysilane, ammonium hydride, water and a surfactant to form an aqueous dispersion of alkyl-modified silsesquioxane resin particles at a solids concentration of, for example, up to 50 weight-percent based on combined weight of alkyl trimethoxysilane, catalyst, surfactant and water. Details of exemplary synthetic processes are in the Examples section below. The resulting dispersion of alkyl-modified silsesquioxane resin particles can be free of methanol by-products and the catalyst (for example, ammonia) because by-products can be removed. Surfactant can also be removed if desired.

The alkyl-modified silsesquioxane resin particles are preferably “essentially non-reactive”, which means that they contain less than 30 mol %, preferably 20 mol % or less, 10 mol % or less, even 5 mol % or less reactive groups selected from Si—OH, Si—OR and Si—H groups relative to total moles of silicon atoms on average per molecule. In contrast, reactive additives such as silanes have 100 mole-percent or more such reactive groups based on total moles of silicon atoms on average per molecule.

The concentration of reactive groups can be determined for alkyl-modified silsesquioxane resin particles by infrared spectroscopy and nuclear magnetic resonance spectroscopy (NMR) using the following procedure: collect a ²⁹Si NMR on a methyl silsesquioxane resin synthesized in methylisobutyl ketone (MIBK) to produce a soluble silanol functional methyl silsesquioxane resin (see example in next paragraph). Determine the silanol content for this resin from the NMR as mol % OH as compared to Si. This value can be used to calibrate the concentration of OH (peak at 1270 cm⁻¹) in an infrared spectrum of the same methyl silsesquioxane resin. Using this type of calibration, the infrared spectrum of an alkyl-modified silsesquioxane resin can be used to determine the concentration of not only OH but of other reactive groups by infrared spectroscopy even if the resin is non-soluble.

As an example of a water soluble silsesquioxane resin synthesis in MIBK, one can follow the following procedure: Load a 2 L 3-nech round bottom flask with 737.1 g deionized water and 334.6 g MIBK. Equip the flask with a polytetrafluoroethylene stir paddle, thermometer and water-cooled condenser. Cool the flask contents to 10° C. using an ice-water bath. Add a premixed solution of methyltrichlorosilane (240.0 g) and MIBK (143.4 g) slowly over 4 minutes 50 seconds. An exothermic reaction raised the temperature to 44° C. Mix for 5 minutes with ice-water bath removed. The temperature drops to 39° C. Transfer the reaction mixture into a one-liter 3-neck round bottom flask with a bottom drain and then remove the aqueous layer along with rag layer. Wash multiple times at room temperature with approximately 60 milliliters of deionized water for each wash until the final wash water has a pH of 4.0. Pressure filter through a 5.0 micrometer filter to obtain a clear filtrate. Strip resin to dryness using a rotovaporator. Remove the bulk of the solvent at 30° C. (15 minutes) and then the remainder at 110° C. (25 minutes). Pour out the resin in an oven and put in an oven at 110° C. for 25 minutes. Resulting resin is brittle solid at 25° C. with slight haze. It is soluble in tetrahydrofuran and deuterated chloroform, but not toluene. Resin has a number averaged molecular weight of 1,415 and a weight average molecular weight of 5,975. Average OH concentration is 36.49 mol % relative to Si atoms.

The alkyl-modified silsesquioxane resin particles have an average particle size of 20 nanometers (nm) or more, and can be 40 nm or more, 50 nm or more, 60 nm or more, 70 nm or more, 80 nm or more, 90 nm or more 100 nm or more, 120 nm or more, 140 nm or more, 160 nm or more, even 180 nm or more while at the same time typically have an average particle size of 200 nm or less, and can have an average particle size of 190 nm or less, 180 nm or less, 170 nm or less, 160 nm or less, 150 nm or less, 140 nm or less, 130 nm or less, 120 nm or less, 110 nm or less, 100 nm or less, 90 nm or less, 70 nm or less, 50 nm or less, even 30 nm or less. Average particle size is volume average particle size as determined by dynamic light scattering (DSL) using a Microtrac Nanotrac Flex 180° DLS particle size analyzer.

The alkyl-modified silsesquioxane resin particles are distributed throughout the inorganic binder. That means that the resin particles are intermixed among inorganic binder particles or, when the binder is set-up, among the inorganic binder matrix throughout the inorganic binder component. That means alkyl-modified silsesquioxane resin particles are not just located on the surface of a binder composition or partially distributed into an inorganic binder composition, but rather distributed all the way throughout the inorganic binder composition. Desirably, the alkyl-modified silsesquioxane resin particles are uniformly distributed throughout the inorganic binder to form a homogeneous mixture of alkyl-modified silsesquioxane resin particles and inorganic binder. That is in contrast to a coating on an inorganic binder matrix that resides only on the surface of an inorganic binder matrix or that penetrates only partially beyond the surface of an inorganic binder matrix.

The composition of the present invention can be an aqueous dispersion of inorganic binder particles mixed with the alkyl-modified silsesquioxane resin particles where the inorganic binder and alkyl-modified resin particles are dispersed in a continuous aqueous phase. Inorganic binder is typically applied as an aqueous dispersion of inorganic binder particles. A benefit of the present invention is that the alkyl-modified silsesquioxane resin particles can be mixed with the aqueous dispersion of inorganic binder particles to distribute throughout the inorganic binder. That facilitates hydrophobizing the inorganic binder because the hydrophobizing agent (alkyl-modified silsesquioxane resin particles) can readily be mixed with an aqueous dispersion of inorganic binder and conform to whatever shape or location the binder is then applied and it further obviates a separate step of coating an inorganic binder that has been cast and set-up from an aqueous dispersion.

The composition of the present invention can also be in the form of an inorganic binder continuous structure (matrix) with the alkyl-modified silsesquioxane resin particles distributed throughout the inorganic binder matrix. When a dispersion of inorganic binder sets up, it forms a continuous inorganic binder matrix. The alkyl-modified silsesquioxane resin particles are distributed throughout the entire binder matrix, preferably uniformly throughout the entire inorganic binder matrix. This is in contrast to alkyl-modified silsesquioxane resin particles residing only on the surface of the inorganic binder matrix or penetrating only partially into the inorganic binder matrix. The alkyl-modified silsesquioxane resin particles are dispersed throughout the inorganic binder matrix as a result of being mixed with the inorganic binder in an aqueous dispersion prior to casting the inorganic binder and allowing it to set-up and dry into a matrix.

The composition desirably comprises 0.05 weight-percent (wt %) or more, and can comprise 0.10 wt % or more, 0.20 wt % or more, 0.30 wt % or more, 0.40 wt % or more, 0.50 wt % or more, 0.60 wt % or more, 0.70 wt % or more, 0.80 wt % or more, even 0.90 wt % or more while at the same time typically comprises 1.0 wt % or less and can comprise 0.90 wt % or less, 0.80 wt % or less, 0.70 wt % or less, 0.60 wt % or less, 0.50 wt % or less, 0.40 wt % or less, 0.30 wt % or less, 0.20 wt % or less, or even 0.10 wt % or less alkyl-modified silsesquioxane resin particles based on composition solids weight. Alkyl-modified silsesquioxane resin particle weight for determining concentration in the composition is solids weight. “Solids” refer to components that remain after driving off volatiles at 150 degrees Celsius (° C.) for 30 minutes.

The composition of the present invention can be an article that comprises inorganic binder with alkyl-modified silsesquioxane resin particles dispersed therein. For instance, one particularly desirable composition of the present invention is what is commonly known as “gypsum board”, which comprises a layer of gypsum with alkyl-modified silsesquioxane resin particles distributed through the gypsum residing between coversheets, or a single coversheet that wraps around the gypsum layer. It is particularly challenging to achieve a hydrophobic gypsum and gypsum board article. The composition of the present invention can provide gypsum and gypsum board articles with alkyl-modified silsesquioxane resin particles distributed throughout the gypsum component thereby hydrophobizing the gypsum throughout the gypsum matrix. That is valuable in case the gypsum cracks or where fasteners extend into the gypsum providing exposure to the interior of the gypsum matrix. Hydrophobic coatings on gypsum are ineffective when the gypsum cracks or where there are holes exposing the interior of the gypsum. Yet the composition of the present invention provides hydrophobic character throughout the gypsum layer—and throughout any inorganic binder matrix in which the alkyl-modified silsesquioxane resin particles are distributed.

The composition can be free of silicone oil. Silicone oil is a polysiloxane such as polydimethylsiloxane that is predominately composed of R₂SiO_{2/2} siloxane units. Silicone oil is typically fluid at or around 25° C. Silicone resins, in contrast to silicone oil, is a crosslinked polysiloxane that may not even have a melting point to form a fluid. The alkyl-modified silsesquioxane resin particles of the present invention, for instance, demonstrate no sign of even having a softening point even up to 250° C. when analyzed by differential scanning calorimetry (DSC), which means they are not liquid or film forming.

The present invention includes a method for making the composition comprising alkyl-modified silsesquioxane resin particles distributed throughout inorganic binder. The method comprises the steps of: (a) providing an aqueous dispersion of inorganic binder and an aqueous dispersion of alkyl-modified silsesquioxane resin particles; and (b) mixing together the aqueous dispersion of inorganic binder and the aqueous dispersion of alkyl-modified silsesquioxane resin particles to form an aqueous dispersion of inorganic binder and alkyl-modified silsesquioxane resin particles. The inorganic binder and alkyl-modified silsesquioxane resin particles are as described herein above for the composition.

The method can further comprise a step (c) that occurs after step (b) where step (c) is drying (removing at least a portion of the water phase) the aqueous dispersion of inorganic binder and alkyl-modified silsesquioxane resin particles sufficiently to achieve an inorganic binder continuous matrix. The inorganic binder will set-up after step (b) and often during or prior to step (c) so as to form a continuous inorganic binder matrix with alkyl-modified silsesquioxane resin particles distributed throughout it. Usually, there is a step between steps (b) and (c) that is casting the aqueous dispersion of inorganic binder and alkyl-modified silsesquioxane resin particles into or onto a location where set-up inorganic binder is desired. For instance, casting can be distributing the dispersion formed in step (b) onto a facer to form gypsum board.

### EXAMPLES

Table 1 lists components for preparing the samples below.

TABLE 1

| Component | Description | Source |
|---|---|---|
| Monomer | Methyltrimethoxysilane (“MTM”) | XIAMETER ™ OFS-6070 silane from |
| | | The Dow Chemical Company. |
| Surfactant | Sodium dodecyl phenyl ether | DOWFAX ™ 2A1 surfactant solution |
| | disulfonate (46 wt % in water) | from The Dow Chemical Company. |
| Base Catalyst | Ammonium hydroxide, 28-30% in | J. T. Baker-Fisher Scientific. |
| | water | |
| Acid Catalyst | Hydrochloric acid (37 wt % in water) | Sigma-Aldrich |
| Capping Agent | Hexamethyldisilazane | Sigma-Aldrich |
| Anion Exchange | Proprietary anion exchange resin | Available as DOWEX ™ MARATHON |
| Resin | beads having a mean particle size of | A OH from The Dow Chemical |
| | 610 +/− 50 micrometers. | Company. |
| Hydrophobizing | Polymethylhydrogen siloxane fluid | Available as XIAMETER ™ MHX-1107 |
| Agent 1 | (CH₃)₃SiO—[(CH₂)HSiO]₆₅—Si(CH₃)₃ | Fluid from The Dow Chemical |
| | | Company. |
| Hydrophobizing | Potassium methyl siliconate | Available as XIAMETER ™ OFS-0777 |
| Agent 2 | (CH₃)Si(O⁻K⁺)₃ | Siliconate from The Dow Chemical |
| | | Company. |
| Gypsum | Pre-Mixed Dry Gypsum Plaster | Available as MP75 from Knauf |

XIAMETER is a trademark of Dow Corning Corporation. DOWFAX is a trademark of The Dow Chemical Company. DOWEX is a trademark of the Dow Chemical Company.

Methyl-T Seed Particles

Add 750 milliliters (mL) of deionized water, 5 grams (g) of Surfactant, 1.125 mL Acid Catalyst into a one-liter borosilicate glass bottle. As a magnetic stir bar and mix at 250 revolutions per minute (RPM). In a separate glass bottle with 37.5 g of MTM. Quickly add the MTM to the solution in the borosilicate glass bottle and continue mixing for about 10 seconds. Allow the mixture to sit for 18 hours without mixing and undisturbed to obtain the Methyl-T Seed Particle solution. Determine the particle size of the resulting Methyl-T seed particles by dynamic light scattering using a Nanotrac Flex 180° dynamic light scattering (DLS) particle size analyzer. The average particle size is 18 nm. The resulting solution is 2.3 wt % solids.

Silsesquioxane Resin Particle “A”

Into a 3-liter 3-neck round bottom indented Morton type flask load 1600 g deionized water 14 g of Surfactant and 1.2 mL of Base Catalyst. Heat the solution to 60° C. while mixing at 250 RPM. Add 200 g of the Methyl-T Seed Particle solution while mixing together with 1.2 mL of Base Catalyst. Into a separate one-liter 3-neck round bottom flask add 435 g of MTM and apply a nitrogen blanket and a polytetrafluoroethylene line for a peristaltic pump to pump the MTM into the 3-liter 3-neck round bottom flask. Pump the MTM into the solution in the 3-liter round bottom flask at a rate of 3.90 grams per minute while mixing. Continue mixing for 30 minutes after addition at a temperature of 60° C. Pour the resulting suspension into 1-Liter bottles. Allow the suspension to sit at 25° C. for 18 hours and then filter through a 150-millimeter Whatman glass fiber filter without binder, particle retention from 0-69 kilopascals (0-10 pounds per square inch). The isolated yield of a dispersion of silsesquioxane resin particles is 2,205.3 grams of dispersion (suspension), which corresponds to 228.2 g of silsesquioxane resin particle solids. The average particle size is 74.77+/−0.858 nm and is 10.35 wt % solids.

Alkyl-Modified Silsesquioxane Resin Particles 1— solvent stripped “A”

Add 1110.5 g of silsesquioxane resin particle “A” into a 2-Liter round bottom flask. Remove methanol and ammonia and some water using a rotovap with the sample heated by an oil bath at 50-55° C. under vacuum (12-21 Megapascals, 90-160 millimeters mercury) until the flask contains 410.8 g of material (28.0 wt % solids)

Repeat with another 1088.8 g of silsesquioxane resin particle “A” until 337.0 g of material remains in the flask (33.4 wt % solids).

Combine the contents of both flasks to obtain Alkyl-Modified Silsesquioxane Resin Particles 1 (average particle size of 75.33+/−1.02 nm, 30.36 wt % solids, and approximately 20 mol % reactive groups relative to silicon atoms).

Alkyl-Modified Silsesquioxane Resin Particles 2—Solvent Stripped and Surfactant Removed “A”

Load a plastic bottle with 380.0 g of Alkyl-Modified Silsesquioxane Resin Particles 1. Add 57.68 g of Anion Exchange Resin beads. Mix for 24 hours at 25° C. Filter through a 250-micrometer polyester paint strainer mesh. The resulting material (“Alkyl-Modified Silsesquioxane Resin Particles 2”) has an average particle size of 72.63+/−1.99 nm, 27.12 wt % solids and approximately 20 mol % reactive groups relative to silicon atoms.

Trimethylsilane-Capped Silsesquioxane Resin Particles B—solvent stripped

Into a 3-liter 3-neck round bottom indented Morton type flask load 1600 g deionized water, 14 g of Surfactant and 1.2 mL of Base Catalyst. Into a separate one-liter 3-neck round bottom flask add 435 g of MTM and apply a nitrogen blanket and a polytetrafluoroethylene line for a peristaltic pump to pump the MTM into the 3-liter 3-neck round bottom flask. Pump the MTM into the solution in the 3-liter round bottom flask at a rate of 3.90 grams per minute while mixing. Continue mixing for 30 minutes after addition at a temperature of 60° C.

Add 38.69 g of hexamethyldisilazane with a syringe pump over 30 minutes. Heat to ° C. for four hours. Allow to set for 18 hours at 25° C. Filter the resulting product suspension at 25° C. through a 150 mm Whatman glass fiber filter without binder, 0.7-micron particle retention.

The isolated yield of a dispersion of alkyl-functional silsesquioxane resin particle is 2,249.3 g of dispersion (suspension), which corresponds to 232.8 g of alkyl-functional silsesquioxane resin particle solids. Remove methanol and ammonia and some water under vacuum on a rotovap using an oil bath at a temperature of 50-55° C. The resulting Trimethylsilane-Capped Silsesquioxane Resin Particles B has an average particle size of 78.57+/−1.84 nm, 30.62 wt % solids, and a reactive group concentration of less than 20 mol % relative to silicon atoms.

Alkyl-Modified Silsesquioxane Resin Particles 3—Surfactant Removed Version of “B”

Load a plastic bottle with 380.0 g of the Trimethylsilane-Capped Silsesquioxane Resin Particles B. Add 58.18 g of Anion Exchange Resin beads. Mix for 24 hours at 25° C. Filter through a 250-micrometer polyester paint strainer mesh. The resulting material (“Alkyl-Modified Silsesquioxane Resin Particles 3”) has an average particle size of 71.93 +/−0.33 nm, 27.17 wt % solids, and less than 20 mol % reactive groups relative to silicon atoms.

Composition Samples

Prepare gypsum samples according the formulations in Table 2, with component values provided in grams of each component. The samples all use the same Gypsum (MP75 from Knauf). The Reference sample is just gypsum without a hydrophobizing agent. Samples 1-5 all include 0.5 wt % of a hydrophobizing agent determined as a wt % of active hydrophobizing agent relative to composition weight. The different hydrophobizing agents have different wt % solids (wt % solids) so different grams of the hydrophobizing agent were used to achieve a constant 0.5 wt % of hydrophobizing active. Samples 1 and 2 incorporate reactive Hydrophobizing Agents 1 and 2. Samples 3, 4 and 5 incorporate alkyl-modified silsesquioxane resin particles 1, 2 and 3 respectively. Each sample was prepared in triplicate.

Prepare each sample by mixing the gypsum, water and, if included, hydrophobizing agent together using a lab mixer to ensure a homogeneous dispersion.

Cast the compositions into silicon elastomer molds that are 10 centimeters by 10 centimeters by one centimeter to cure into solids. Level off the top surface of the mold with a scraper. Leve the cast samples to set for one day, demold and allow to further dry for 7 days at 25° C.

TABLE 2

| | | | Hydrophobizing agent | | |
|---|---|---|---|---|---|
| | | | | | Wt % |
| | | | | | Active in |
| | | | | | Hydro- |
| | Water | Gypsum | | | phobizing |
| Sample | (g) | (g) | Identity | (g) | Agent |

Reference

| | | | |
|---|---|---|---|
| (a) | 315 | 450 | (N/A) |
| (b) | 315 | 450 | (N/A) |
| (c) | 315 | 450 | (N/A) |

Sample 1

| | | | | | |
|---|---|---|---|---|---|
| (a) | 315 | 450 | Hydrophobizing Agent 1 | 2.25 | 100 |
| (b) | 315 | 450 | Hydrophobizing Agent 1 | 2.25 | 100 |
| (c) | 315 | 450 | Hydrophobizing Agent 1 | 2.25 | 100 |

Sample 2

| | | | | | |
|---|---|---|---|---|---|
| (a) | 311.6 | 450 | Hydrophobizing Agent 2 | 5.63 | 40 |
| (b) | 311.6 | 450 | Hydrophobizing Agent 2 | 5.63 | 40 |
| (c) | 311.6 | 450 | Hydrophobizing Agent 2 | 5.63 | 40 |

Sample 3

| | | | | | |
|---|---|---|---|---|---|
| (a) | 310.6 | 450 | Alkyl-Modified | 7.37 | 30.36 |
| | | | Silsesquioxane Resin | | |
| | | | Particles 1 | | |
| (b) | 310.6 | 450 | Alkyl-Modified | 7.37 | 30.36 |
| | | | Silsesquioxane Resin | | |
| | | | Particles 1 | | |
| (c) | 310.6 | 450 | Alkyl-Modified | 7.37 | 30.36 |
| | | | Silsesquioxane Resin | | |
| | | | Particles 1 | | |

Sample 4

| | | | | | |
|---|---|---|---|---|---|
| (a) | 310.2 | 450 | Alkyl-Modified | 7.96 | 27.12 |
| | | | Silsesquioxane Resin | | |
| | | | Particles 2 | | |
| (b) | 310.2 | 450 | Alkyl-Modified | 7.96 | 27.12 |
| | | | Silsesquioxane Resin | | |
| | | | Particles 2 | | |
| (c) | 310.2 | 450 | Alkyl-Modified | 7.96 | 27.12 |
| | | | Silsesquioxane Resin | | |
| | | | Particles 2 | | |

Sample 5

| | | | | | |
|---|---|---|---|---|---|
| (a) | 310.1 | 450 | Alkyl-Modified | 8.08 | 27.17 |
| | | | Silsesquioxane Resin | | |
| | | | Particles 3 | | |
| (b) | 310.1 | 450 | Alkyl-Modified | 8.08 | 27.17 |
| | | | Silsesquioxane Resin | | |
| | | | Particles 3 | | |
| (c) | 310.1 | 450 | Alkyl-Modified | 8.08 | 27.17 |
| | | | Silsesquioxane Resin | | |
| | | | Particles 3 | | |

Cast Sample Characterization

Characterize the cast and dried Samples for hydrophobicity using two different characterization tests:

Contact Angle—Surface Hydrophobicity

Deposit one drop from a plastic pipette of deionized water onto a surface of the dried Sample and observe the appearance of the bead for 30 seconds and then evaluate the appearance of the drop. Conduct the evaluation on both primary surfaces (10 cm by 10 cm surfaces) of the Samples. Grade the water bead appearance according to the following scale:
5: bead complete absorbed into sample.
4: strong wetting, darkening of the sample surface.
3: wetting of the sample surface, but not darkening of the surface
2: little wetting of surface, contact angle near 90° without darkening of sample surface
1: contact angle close to 135° or more, essentially non-wetting.

Immersion Water Absorption—Bulk Hydrophobicity

Weight a Sample to get a “dry” mass Immerse the Sample completely under deionized water for 2 hours. Weight the Sample again to get a “wet” mass. The difference in mass (wet-dry) is the amount of water absorbed. Identify wt % water absorbed relative to dry mass.

Table 3 contains the results of these characterization for the 5 different Samples.

The data in Table 3 reveals that the alkyl-modified silsesquioxane resins particles are effective hydrophobizing agents for inorganic binder and perform at least as well as a hydrophobizing agent as the reactive hydrophobizing agents of Samples 1 and 2. The data also reveals that performance is independent of whether the surfactant is removed from the alkyl-modified silsesquioxane resin particle or not.

TABLE 3

| | | | Water Uptake | | | |
|---|---|---|---|---|---|---|
| | Surface | | | | | Average |
| | Hydrophobicity | | Dry | Wet | Wt % | Wt % |
| | First | Second | Mass | Mass | Water | Water |
| Sample | Side | Side | (g) | (g) | Absorbed | Absorbed |

Reference

| | | | | | | |
|---|---|---|---|---|---|---|
| (a) | 5 | 5 | 146.27 | 199.09 | 36.1 | 36.11 |
| (b) | 5 | 5 | 146.73 | 199.11 | 35.70 | |
| (c) | 5 | 5 | 137.25 | 187.35 | 36.50 | |

Sample 1 (Hydrophobizing Agent 1)

| | | | | | | |
|---|---|---|---|---|---|---|
| (a) | 2 | 1 | 121.71 | 125.25 | 2.93 | 2.98 |
| (b) | 2 | 1 | 126.96 | 130.62 | 2.89 | |
| (c) | 2 | 1 | 114.37 | 117.92 | 3.10 | |

Sample 2 (Hydrophobizing Agent 2)

| | | | | | | |
|---|---|---|---|---|---|---|
| (a) | 2 | 3 | 135.17 | 138.26 | 2.29 | 2.31 |
| (b) | 2 | 3 | 136.74 | 139.81 | 2.25 | |
| (c) | 2 | 3 | 132.50 | 135.68 | 2.40 | |

Sample 3 (Alkyl-Modified Silsesquioxane Resin Particles 1)

| | | | | | | |
|---|---|---|---|---|---|---|
| (a) | 3 | 2 | 128.51 | 131.94 | 2.67 | 2.60 |
| (b) | 3 | 2 | 132.64 | 136.13 | 2.63 | |
| (c) | 3 | 2 | 147.98 | 151.68 | 2.50 | |

Sample 4 (Alkyl-Modified Silsesquioxane Resin Particles 2)

| | | | | | | |
|---|---|---|---|---|---|---|
| (a) | 2 | 1 | 132.01 | 135.65 | 2.76 | 2.72 |
| (b) | 2 | 1 | 135 | 138.64 | 2.70 | |
| (c) | 2 | 1 | 130.66 | 134.19 | 2.71 | |

Sample 5 (Alkyl-Modified Silsesquioxane Resin Particles 3)

| | | | | | | |
|---|---|---|---|---|---|---|
| (a) | 3 | Not | 131.52 | 135.40 | 2.95 | 2.88 |
| | | measured | | | | |
| (b) | 3 | Not | 127.83 | 131.59 | 2.94 | |
| | | measured | | | | |
| (c) | 3 | Not | 141.59 | 145.49 | 2.75 | |
| | | measured | | | | |

Reduced Amounts of Alkyl-Modified Silsesquioxane Resin Particles

Table 4 present Immersion Water Absorption results for additional Samples prepared using 0.4 wt %, 0.3 wt %, 0.2 wt % and 0.1 wt % Alkyl-Modified Silsesquioxane Resin Particles 1 to explore the effectiveness of the alkyl-modified silsesquioxane additive at lower concentrations. Prepare the samples in similar fashion as Sample 3, but with the reduced amount of Alkyl-Modified Silsesquioxane Resin Particles 1.

The data in Table 4 reveals that even at loadings as little as 0.1 wt % the alkyl-modified silsesquioxane resin particles are effective hydrophobizing agent for the inorganic binder.

TABLE 4

| | | | | | |
|---|---|---|---|---|---|
| | | Dry | Wet | Wt % | Average Wt % |
| | Concentration | Mass | Mass | Water | Water |
| Sample | of Additive | (g) | (g) | Absorbed | Absorbed |

Sample 6

| | | | | | |
|---|---|---|---|---|---|
| (a) | 0.4 wt % | 130.47 | 131.78 | 1.01 | 0.97 |
| (b) | | 133.63 | 134.90 | 0.95 | |
| (c) | | 129.48 | 130.73 | 0.96 | |

Sample 7

| | | | | | |
|---|---|---|---|---|---|
| (a) | 0.3 wt % | 139.19 | 140.58 | 1.00 | 1.05 |
| (b) | | 146.66 | 148.09 | 0.97 | |
| (c) | | 123.84 | 125.31 | 1.19 | |

Sample 8

| | | | | | |
|---|---|---|---|---|---|
| (a) | 0.2 wt % | 137.19 | 138.58 | 1.01 | 1.00 |
| (b) | | 133.22 | 134.53 | 0.99 | |
| (c) | | 128.71 | 129.99 | 0.99 | |

Sample 9

| | | | | | |
|---|---|---|---|---|---|
| (a) | 0.1 wt % | 131.28 | 132.71 | 1.09 | 1.38 |
| (b) | | 144.93 | 146.45 | 1.05 | |
| (c) | | 141.88 | 144.73 | 2.00 | |

Study of Aged Reactive Additive

An advantage to using a hydrophobizing additive that is essentially non-reactive as opposed to a reactive hydrophobizing agent is shelf stability of the additive. It can be desirable to formulate a dispersion of a hydrophobizing additive in bulk and store it for a period of time prior to use. That way, formulating the hydrophobizing agent does not have to occur directly when making the inorganic binder composition. However, reactive hydrophobizing agents tend to be unstable to storage in an aqueous dispersion due to their tendency to react while in storage. Essentially non-reactive dispersions do not have the reactive sites that cause the instability so they are expected to be more storage stable.

The following provides an illustration of the instability of reactive hydrophobizing agents using XIAMETER™ OFS-6070 Silane, an alkoxy silane reactive hydrophobizing agent. XIAMETER is a trademark of Dow Corning Corporation.

Add H₂SO₄ to tap water to obtain a pH of 2.9. Gently pour XIAMETER™ OFS-6070 Silane into the acidic aqueous solution over 20 seconds while mixing to achieve a hydrophobizing solution that has 50 wt % active content of the silane. Allow the solution to age for specified periods of time (see Table 5) before testing their hydrophobizing effect on gypsum.

Prepare gypsum samples comprising the hydrophobizing solution as follows. Mix g of the hydrophobizing agent with 780 g of tap water for 15 seconds with an IKA mixer. Add 1 kilogram of gypsum power over 15-30 seconds. Vigorously mix the resulting slurry for 30 seconds at 1200 revolutions per minute after the addition of gypsum power is complete. The slurry is pourable at this point. Pour into 10-cm×10-cm×1-cm molds and level off the molds with a scraper. Allow the molds to set for 20 minutes and then demold the gypsum samples and place them in an oven at 110° C. for 30 minutes to cure. Then place the gypsum samples at 40° C. for 12 to 24 hours until they achieve a stable weight. Evaluate the hydrophobic character of the samples according to the Immersion Water Absorption test described above. Results for various aged hydrophobizing solutions are in Table 5.

TABLE 5

| Hydrophobizing Solution Age | Water Uptake of Gypsum Sample |
|---|---|
| (days) | (wt % of dry Sample) |
| 0 (fresh) | 5.3 |
| 2 | 9.0 |
| 4 | 23 |
| 10 | 43 |

The data reveals that the hydrophobizing effect of the hydrophobizing solution rapidly decreases with age, resulting in nearly twice as much water absorption even after storing for 2 days.

1. A composition comprising a mixture of a gypsum and alkyl-modified silsesquioxane resin particles made in an aqueous mixture of alkyl trimethoxy silane, catalyst, water and a surfactant to form an aqueous dispersion of alkyl-modified silsesquioxarie resin particles, where the alkyl-modified silsesquioxane resin particles are distributed throughout the and have an average particle size in a range of 20 to 200 nanometers as determined by dynamic light scattering.

2. (canceled)

3. The composition of claim 1, wherein the composition is an aqueous dispersion of gypsum particles and the alkyl-modified silsesquioxane resin particles dispersed in an aqueous continuous phase.

4. The composition of claim 1, wherein the concentration of alkyl-modified silsesquioxane resin particles is to 1.0 weight-percent alkyl-modified silsesquioxane resin particle solids relative to composition solids weight.

5. The composition of claim 1, wherein the alkyl-modified silsesquioxane resin particles contain less than 30 mole-percent of combined Si—OH, Si—OR and Si—H functionality relative to moles of Si atoms as determined by infrared spectroscopy and nuclear magnetic resonance spectroscopy.

6. The composition of claim 1, wherein the composition is part of a gypsum board where the composition resides between coversheets.

7. A method for preparing the composition of claim 1, the method comprising: (a) providing an aqueous dispersion of gypsum and an aqueous dispersion of alkyl-modified silsesquioxane resin particles have an average particle size in a range of 20 to 200 nanometers as determined by dynamic light scattering where the aqueous dispersion is made in an aqueous mixture of alkyl trimethoxy silane, catalyst, water and a surfactant; and (b) mixing together the aqueous dispersion of gypsum and the aqueous dispersion of alkyl-modified silsesquioxane resin particles to form an aqueous dispersion of gypsum and alkyl-modified silsesquioxane resin particles.

8. The method of claim 7, further comprising step (c) after step (b) where step (c) is drying the aqueous dispersion of gypsum and alkyl-modified silsesquioxane resin particles sufficiently to achieve a gypsum continuous matrix with alkyl-modified silsesquioxane resin particles distributed throughout the matrix.
